(19) United States
(12) Patent Application Publication
(10) Pub. No.: US 2024/0410084 A1
(43) Pub. Date: Dec. 12, 2024

(54) ENHANCED FIBRE

(71) Applicant: GALE PACIFIC LIMITED, Braeside, Victoria (AU)

(72) Inventors: Andrew NASARCZYK, Braeside, Victoria (AU); Tony GRIGORIADIS, Braeside, Victoria (AU)

(21) Appl. No.: 18/698,212

(22) PCT Filed: Oct. 6, 2022
(86) PCT No.: PCT/AU2022/051194

§ 371 Date: Apr. 3, 2024

(30) Foreign Application Priority Data
Oct. 6, 2021 (AU) 2021903197

(51) Int. Cl. D01F 9/10; C01B 32/05

(52) U.S. Cl. CPC D01F 9/10; C01B 32/05; D10B 2401/04

(57) ABSTRACT

A method of enhancing a fibre from a staple fibre precursor comprising: obtaining a staple fibre precursor, tensioning and aligning the fibre precursor along a fibre axis and subjecting the aligned staple fibre to an oxidation process, wherein the oxidation process comprises subjecting the tensioned fibre precursor to a general gradient of increasing temperatures in successive multiple stabilisation/oxidation ovens, the ovens ranging in temperature from 50 to 500 degrees Celsius.

### TECHNICAL FIELD

The invention relates to a method of enhancing a fibre, and a fibre. Specifically, the invention relates to a method of enhancing a fibre to improve its fire resistance, durability and insulative properties, and a fibre possessing enhanced fire resistance, durability and insulative properties. It is to be appreciated that the present invention may be incorporated into a wide variety of fabrics to be used in a wide variety of applications.

### BACKGROUND OF INVENTION

The discussion of the background to the invention that follows is intended to facilitate an understanding of the invention. However, it should be appreciated that the discussion is not an acknowledgement or admission that any aspect of the discussion was part of the common general knowledge as at the priority date of the application.

Throughout this specification the terms oxidation and oxidisation are used interchangeably. Both terms are used in reference to the same process.

Advancement of material technology has seen the development and use of fibres possessing highly desirable qualities such as fire resistance, light weight, and high tensile and compressive strength. One such fibre is carbon fibre

Carbon fibre is a low-density material with a very high strength to weight ratio, high chemical resistance, high temperature tolerance and low thermal expansion. The process of manufacturing carbon fibres involves obtaining polyacrylonitrile (PAN) based precursor or the more expensive pitch fibre precursor and subjecting the precursor fibres to a number of processing stages including thermal stabilisation/oxidation in an air atmosphere, followed by a carbonisation stage involving initial low-temperature carbonisation which progresses to high-temperature carbonisation.

The structure and properties of carbon fibres are developed by subjecting the PAN based precursor to a heat stabilisation/oxidation process. Moreover, structural transformations in fibres during this process results in the PAN fibres developing flame resistance and thus allows the fibres to withstand high temperatures during carbonisation.

The desirable characteristics of carbon fibre do come at a relatively significant cost in terms of price, manufacturing time, and adverse environmental effects. The market rate of carbon fibre varies and is estimated to cost between USD$35-50 per kg.

The high price of carbon fibre is partially attributed to the specifically engineered PAN precursors required to make carbon fibre. The manufacturing process is over 10 times more energy intensive in comparison to steel production. Further, there is no effective way to recycle and reuse carbon fibre.

Although Carbon fibres possesses high strength properties, they are incredibly brittle. Due to this brittleness, it is quite difficult to process a carbon fibre in a woven fabric, or in a warp knit, as the weaving and knitting process can result in breakage of the carbon fibre. This significantly limits the use of carbon fibres and processing equipment available. Further, as carbon fibres are continuous filaments, any damage to one section of a filament effects the entire fibre filament, meaning extra caution must be taken when dealing with such fibres. Additionally, as carbon fibre is highly conductive, carbon remnants and residue shed by the fibre is also highly conductive. The dust is quite hazardous to electronics if allowed to build up, the dust can short-circuit electrical components. Any manufacturer of carbon fibre, or any manufacturer seeking to incorporate carbon fibres in their product, must use specialised equipment to protect electronics from the highly conductive dust. Ultimately, the brittleness of the carbon fibre along with the ease of damage are technical disadvantages which limit the use of carbon fibre.

Alternatives to carbon fibre do exist, such as graphene and polylactic acid (PLA) thermoplastic composites. However, such alternative materials are either difficult to manufacture in large quantities and/or are not available in commercial quantities. Further alternatives, such as fibreglass are used due to their relatively low cost, however these alternatives do not possess the wide range of desirable features of carbon fibre and do have limitations which deter manufacturers from using them. For example, fibre glass is susceptible to warpage, low weld strength, and low knit line strength, higher viscosity of melt, and low surface quality which results in abrasion to manufacturing tools.

Oxidised PAN fibres (OPF) also exist. OPFs are predominantly used in flame resistant fabrics due to their fire-resistant properties. Their fire resistance is attributed to having a relatively high Limiting Oxygen Index (LOI) range. However, the precursor to such fibres is expensive.

It is desirable to manufacture a fibre that to an extent possesses at least some of the qualities of carbon fibre or OPFs, at a lower cost. Specifically, it is desirable to provide a relatively low-cost fibre which has a high resistance to fire and combustibility, and which complies with AS1530.1 (methods for fire tests on building materials, components and structures).

### SUMMARY OF INVENTION

In basic terms, carbon fibre and OPFs originate from a base fibre. Said base fibre is a specifically engineered Polyacrylonitrile fibre (PAN) or a pitch fibre. The fibre has a tailored chemistry which enables it to go through; (a) an oxidisation/stabilisation process which transforms the fibre into an OPF, and (b) a carbonization process which eventually transforms the fibre into carbon fibre.

PAN fibres and pitch fibres, which are filament fibres come in different grades. For example, there exists textile grade PAN precursors (which are filament fibres), and carbon fibre PAN precursors (which are also filament fibres), both of which are derived from petroleum. A key characteristic of these filament fibres is that they are of indefinite length, which makes them much stronger than cheaper non-filament fibres and much more reliable to work with during the carbon fibre manufacturing process.

During the oxidisation process, the PAN fibre is heated to burn off contaminants and side chains so as to make it thermally stable. The base fibre typically starts off white in colour and goes through a series of heating ovens (typically 4 to 8) and eventually turns black. Once the fibre is thermally stable, it is carbonised. The carbonisation process typically involves running the thermally stabilised fibre through two furnaces (low and high temp) within a temperature range of 900° C. to 1500° C. As a result of the carbonisation process the fibre forms a predominantly carbon structure (that is tightly bonded carbon crystals are formed).

As noted in the preceding background section, the manufacturing process of carbon fibre is resource intensive and expensive. Further, the advanced properties derived due to the intensive manufacturing process which includes the steps of oxidisation, carbonisation, and stabilisation, may not necessarily be required for a general-purpose fibre. Rather, it may be desirable to provide a versatile general purpose material which, for example, may not necessarily have a tensile strength as high as that of carbon fibre, or be as conductive as the carbon fibre.

Much research has gone into the optimisation of the oxidisation and carbonisation processes so as to reduce the cost of manufacturing carbon fibre. However, the Applicant has discovered that oxidating a staple fibre pre-cursor results in a versatile multi-purpose fibre having comparable desirable fire resistance, strength and flexibility, and that such a fibre can be developed at a significantly lower cost than carbon fibre.

According to a broad aspect of the invention there is provided a method of enhancing a fibre from a staple fibre precursor comprising: obtaining a staple fibre precursor, tensioning and aligning the fibre precursor along a fibre axis and subjecting the aligned staple fibre to an oxidation process, wherein the oxidation process comprises subjecting the tensioned fibre precursor to a gradient of increasing temperatures in successive multiple stabilisation/oxidation ovens, the ovens ranging in temperature from 50 to 500 degrees Celsius.

The use of a staple fibre precursor as opposed to a filament fibre precursor results in significant cost savings. Staple fibres are traditionally significantly cheaper than tailor engineered filament fibre precursors used in the manufacture of carbon fibre. Additionally, not subjecting the oxidated staple fibre to a carbonisation and surface treatment not only reduces the manufacturing time, but it eliminates costly components from the manufacturing process relative to carbon fibre manufacturing. This novel method is advantageous in that the properties of a staple fibre precursor are enhanced so as to be somewhat comparable to carbon fibre, but done so at a fraction of the cost, whilst also addressing the disadvantage of brittleness, i.e. it is more ductile. The oxidated staple fibre at the very least possesses a similar fire resistance to that of a carbon fibre, but is produced at significantly lower cost.

It is acknowledged that the use of a staple fibre precursor, along with the removal of the carbonisation phase and the removal of the surface treatment phase results in a fibre that may possess comparable but slightly inferior material properties compared to carbon fibre. In this respect the Applicant accepts that oxidated staple fibre likely may have a lower strength rating but is more ductile which is quite desirable, a drastically lower conductivity which is actually desirable in some instances, and a comparable but potentially lower fire resistance compared to carbon fibre. In this respect, the enhanced fibre may not be suitable for use as a substitute to carbon fibre in certain niche circumstances, such as formula one vehicle components.

However, it has been found that the low-cost enhanced fibre generated from the novel method of the present invention is much more versatile as it shares some of the desirable properties of carbon fibre, addresses the shortcoming of brittleness, is cheaper to manufacture, and easier to use in a manufacturing environment. The enhanced fibre is less susceptible to damage as it is comprised of a staple fibre precursor having multiple stands reinforcing one another. Damage to one portion or strand will not comprise the entire fibre like damage to a filament fibre would. Further, the enhanced fibre precursor is less susceptible to damage as it is not anywhere near as brittle as carbon fibre. Rather it is ductile, making it more versatile as it can be used on conventional knitting and weaving manufacturing equipment without breaking. This avoids the need to modify the weaving or knitting process to accommodate for a highly brittle fibre. Further, as remnants and dust particles shed by the enhanced fibre are not conductive, they do not pose a significant risk to the electronics of expensive manufacturing equipment. Further, the strength, fire resistance and other properties of the oxidated fibre, along with its resilience allows the fibre to be used for a wide range of products without making the product cost inhibitive. The enhanced fibre can be integrated into protective screening, clothing, carpet, and general building materials and cladding where fire resistance is critical.

The specific properties of the oxidised staple fibre can be adjusted by amending the duration of the oxidation process, along with the temperature gradient of the oxidation process. In one form of the invention, the oxidisation process of the method comprises passing the staple fibre precursor through at least two ovens. The ovens may range in temperature from 50 to 500 degrees Celsius.

In another form of the invention, the oxidisation process of the method comprises passing the staple fibre precursor through at least three ovens, or at least four ovens. In a particular embodiment, the oxidation process may involve the staple fibre precursor passing through six ovens. The ovens may range in temperature from 50 to 500 degrees Celsius.

As previously noted, the ovens are successively arranged in a general gradient of increasing temperature. Where the precursor is passed through more than two ovens, it is possible that two adjacent ovens are run at the same temperature, or slightly varied temperatures.

In an alternative embodiment, the ovens may not necessarily be arranged in a temperature ascending order. For example, the first oven may be set to a fixed temperature of 450 degrees Celsius, the second oven may be set to a fixed temperature of 200 degrees Celsius, and the third oven may be set to a fixed temperature of 220 degrees Celsius. In a further alternative embodiment, the ovens may be set to vary in temperature during the resident time the fibre is subjected to an ovens heat. For example, an oven may cycle in between 200 degrees Celsius and gradually increase to 300 degrees Celsius, and then gradually decrease in temperature back to 200 Celsius.

The temperature at which the ovens are set during the oxidisation phase may range from 100 to 350 degrees Celsius, or from 150 to 300 degrees Celsius, or from 200 to 240 degrees Celsius.

The time the staple fibre precursor spends in each oven, referred to as a ‘residence time’ or ‘resident time’, can vary between 2 minutes and up to 60 minutes. On a relatively small scale, the resident time in each oven may be approximately 25 to 30 mins. The resident time may reduce in a large-scale manufacturing facility.

The order in which the ovens are placed, and their temperature ranges may be configured so as to impart certain characteristics to the precursor. For example, if a higher fire resistance is required, the ovens may be arranged in ascending temperature order with a slow gradient increase from a relatively low temperature to a relatively high temperature. It is to be appreciated that a higher oven resident time, or higher oven temperatures may yield a higher fire/flame resistance, however this may also result in a decrease in ductility. The Inventors have sought oven temperatures and fibre resident times that yield a desirable balance of fire resistance and ductility for a general-purpose fibre. However, it is to be appreciated that the fibre properties may be tailored to a particular use requiring a lower ductility and a higher fire resistance.

The precursor fibre can be of comprised any material, provided it is a staple fibre. In one form of the invention, the composition of the staple fibre is comprised at least substantially entirely of naturally occurring materials, i.e., not man made/synthesised. In this respect, the staple fibre may be comprised of a single, or multiple natural occurring materials. For example, the staple fibre may be comprised of at least one of or a combination of cotton, hemp, flax, jute, silk or wool. This list of naturally occurring materials is non-exhaustive.

In an alternative embodiment the composition of the staple fibre may be comprised of a combination of naturally occurring materials and synthetic materials. In a further alternative embodiment, the composition of the staple fibre may be comprised at least substantially entirely of synthetic materials. Examples of synthetic materials included in the composition of the staple fibre precursor may be at least one or a combination of viscose, nylon, polyester, acrylic. This list of synthetic materials is not exhaustive.

The dimensions and density of the precursor staple fibre influences certain properties of the oxidated enhanced fibre such as, stiffness/rigidity, and ductility. In one form of the invention the staple fibre precursor may be a short staple fibre wherein the fibre lengths of the staple fibre range between 0.01 mm to 2.40 mm.

In an alternative embodiment the staple fibre precursor may be a medium staple fibre wherein the fibre lengths of the staple fibre range between 2.40 mm to 2.90 mm. In a further alternative embodiment, the staple fibre may be a long staple fibre wherein the fibre lengths of the staple fibre range between 2.90 mm to 3.50 mm.

In a further alternative embodiment, the precursor staple fibre may be comprised of fibres of varying length, wherein the length of the individual fibres range between 0.01 mm to 5.00 mm.

In any of the above-mentioned embodiments, the diameter of the staple fibre precursor may be as small as 0.01 mm and as large as 5.0 mm.

In one specific embodiment, the staple fibre precursor is at least substantially acrylic. Specifically, the staple fibre may be at least approximately 95% acrylic. In one specific embodiment, the staple fibre precursor is 100% acrylic, and has a fibre count of 7.5/3+3.5% Nm (Metric Yarns, measured in metres per 1 gram of mass), approximately 135+5% twists per meter (TPM), a shrinkage of approximately 20-22%, a strength of approximately 52 Newtons+5%.

The yarn weight of the staple fibre precursor can vary be varied depending on the end use of the oxidated fibre. For example, the staple fibre precursor may comprise a fibre count anywhere between Nm 20/1 to Nm 5/5 and in a preferred embodiment Nm7.5/3+3.5%. The staple fibre precursor may be comprised of approximately 135+5% (TPM).

In an embodiment, the staple fibre precursor is comprised of the following: 100% acrylic non-high bulk; semi dull or dull fibre spun; a count range of 6 to 32 Nm; and a ply range of 1 to 6 ply. The precursor staple fibre may comprise for example a 4 ply, and a count of 10 Nm.

Although the oxidated staple fibre may have a comparably lower strength rating, conductivity, and fire resistance compared to carbon fibre, the enhanced fibre has been found to be more versatile while still possessing similar but lower performance properties. The relatively low-cost enhanced fibre 14 generated from the novel method of the invention is much more versatile as it is less brittle, more ductile, cheaper, quicker and less complex to produce, and easier to use in a manufacturing environment due to the enhanced fibre's ductility and lower conductivity. Unlike carbon fibre, the enhanced oxidated staple fibre is less susceptible to damage, due to being comprised of a plurality of strand which act to reinforce each other, which is unlike a filament type carbon fibres. Further due to the ductility of the enhanced fibre, it is able to be used on conventional weaving a knitting equipment. Further, as the remnants and dust particles shed by the enhanced fibre have low or poor conductivity, the enhanced fibre do not pose create the hazard or significant risk of short-circuiting electronics of expensive manufacturing equipment. Further, the strength, fire resistance and other properties of the oxidated/enhanced fibre, along with its resilience allows the fibre to be used in the composition of a wide range of products without making the production cost inhibitive. As a result, the enhanced fibre can be integrated into a wide variety of products such as clothing, protective screening, curtains, and cladding.

Where any or all of the terms “comprise”, “comprises”, “comprised” or “comprising” are used in this specification (including the claims) they are to be interpreted as specifying the presence of the stated features, integers, steps or components, but not precluding the presence of one or more other features, integers, steps or components.

### BRIEF DESCRIPTION OF DRAWINGS

It will be convenient to hereinafter describe a preferred embodiment of the invention with reference to the accompanying drawings. The particularity of the drawings is to be understood as not limiting the preceding broad description of the invention.

FIG. 1 is a basic diagram of the prior art carbon fibre manufacturing process.

FIG. 2 is a basic diagram of the method of the current invention through which a staple fibre is enhanced.

### DETAILED DESCRIPTION

### Carbon Fibre

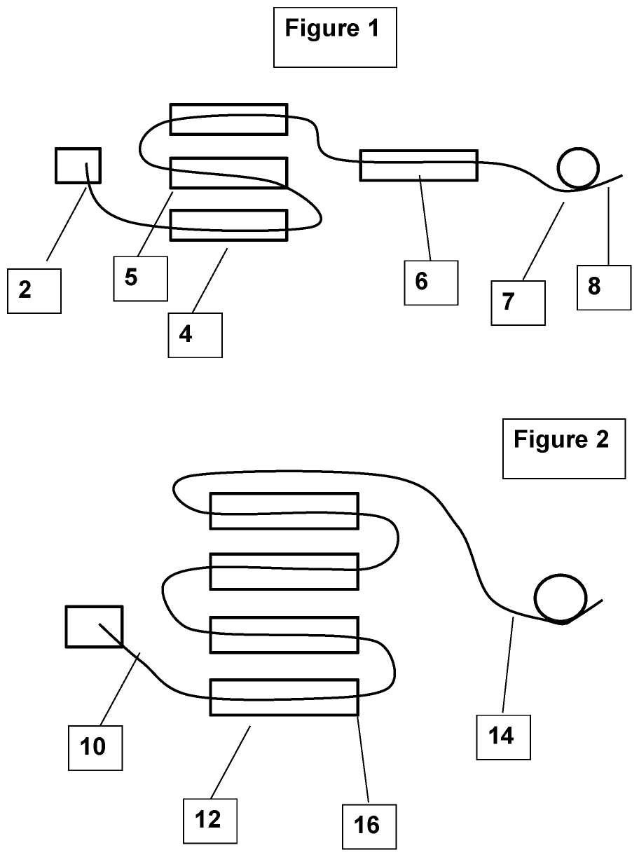

Referring to FIG. 1, there is illustrated a schematic diagram of the prior art carbon fibre manufacturing process. The process starts with a specifically engineered precursor 2, which is a continuous filament precursor. The precursor 2 used is typically an engineered PAN or pitch filament fibre precursor. The precursor 2 is an organic polymer, characterized by long strings of molecules bound together by carbon atoms. The exact composition of each precursor 2 varies between manufacturers and suppliers and is generally considered a trade secret.

The precursor fibre 2 has a tailored chemistry which enables it to go through; (a) an oxidisation/stabilisation process 4 which transforms the fibre into an OPF, and (b) a carbonization 6 process which eventually transforms the fibre into a carbon fibre 8.

Before the precursor 2 is carbonized, it needs to be chemically altered to convert its linear atomic bonding to a more thermally stable ladder bonding. This is achieved by subjecting the specifically engineered precursor 2 to an oxidation/stabilisation process 4. The process 4 involves passing the precursor 2 through a series of ovens 5 ranging between 200° C. to 300° C. The ovens 5 may be heat chambers through which the precursor 2 is drawn, or a series of heated rollers over which the precursors are passed. In the oxidation process 4 oxygen molecules from the air are combined with the specifically engineered precursor 2 (PAN or pitch fibres) in the warp and causes the polymer chains to start crosslinking resulting in the rearrangement of the precursor's 2 atomic bonding pattern. This increases the density of the precursor 2. As a result, the precursor develops a more thermally stable ladder bonding.

After the oxidation process 4, the oxidated precursor 2 is then subjected to a carbonisation process 6. In the carbon fibre process 6, the precursor 2 is heated to a temperature in the range of approximately 1,000-3,000° C. for several minutes in a furnace (not shown in the drawings) filled with a gas mixture that does not contain oxygen. The lack of oxygen prevents the precursor fibres 2 from burning. The gas pressure inside the furnace is kept higher than the outside air pressure. The points where the precursor 2 enter and exit the furnace are sealed to keep oxygen from entering. As the precursor 2 is heated, it predominantly sheds non-carbon atoms in the form of various gases including water vapor, ammonia, carbon monoxide, carbon dioxide, hydrogen, and nitrogen. As the non-carbon atoms are expelled, the remaining carbon atoms form tightly bonded carbon crystals that are aligned more or less parallel to the long axis of the precursor 2. The carbonisation process 6 is not limited to using a single furnace, and in some instances multiple furnaces operating at different temperatures are used to better control the rate of heating during carbonization.

After the carbonisation process 6, the carbonised precursor 2 is subjected to further slight oxidation to allow it to better bond with other materials. This is known as surface treatment 7. The addition of oxygen atoms to the precursor 2 surface provides better chemical bonding properties and also etches and roughens the surface for better mechanical bonding properties. This further slight oxidation can be achieved by immersing the precursor 2 in various gases such as air, carbon dioxide, or ozone; or in various liquids such as sodium hypochlorite or nitric acid. The precursor 2 can also be coated electrolytically. The surface treatment process 7 must be carefully controlled so as to avoid the formation of miniscule surface defects, such as pits, which could cause failure. Following the surface treatment 7, the carbon fibre 8 may be coated to prevent it from damage during winding or weaving. Typical coating materials include epoxy, polyester, nylon, urethane, and others. Coated fibres 8 are wound onto bobbins and are eventually twisted into yarns of various sizes.

### Disadvantages of Carbon Fibre Manufacturing

As previously noted, the manufacturing process of carbon fibre 8 is resource intensive, expensive and the carbonisation process 6 in particular results in the generation of noxious gases, in particular ammonia. Further, the brittleness of the carbon fibre 8 results in a significant limitation in the end use of the fibres, as it is susceptible to breakage. Further, the use of a filament fibre precursor 2 means that any damage to a section of a fibre will render the entire fibre comprised.

In developing the fibre of the present invention, it has been determined that there is demand for a general-purpose fibre that does not necessarily possess all of the properties of carbon fibre, and one that is ductile.

The advanced properties derived due to the intensive carbon fibre manufacturing process which includes the steps of oxidisation 4, carbonisation 6, and surface treatment 7, may not necessarily be required for a general-purpose fibre such as consumer clothing.

The inventors have developed a versatile general-purpose material, which possess comparable but generally lower performance properties to carbon fibre, for example, a lower tensile strength, and a lower conductivity. However, the compromise in certain performance properties has allowed the general-purpose fibre 14 of FIG. 2 to be developed at a relatively lower cost and to be more ductile and versatile than carbon fibre.

### New Method

FIG. 2 provides a novel method of enhancing a fibre. In comparison to the method in which carbon fibre is manufactured, the present invention does not utilise a highly engineered PAN or Pitch fibre 2. Rather, the present invention utilises a staple fibre precursor 10. The use of a staple fibre precursor 10 as opposed to a filament fibre precursor 2 results in significant cost savings. Staple fibres 10 are traditionally significantly cheaper than tailor engineered filament fibre precursors 2 used in the manufacturing process of carbon fibre.

The method of FIG. 2 entirely excludes the carbonisation process 6 of FIG. 1, resulting in a significant time and cost saving in the manufacturing of the enhanced fibre. As a result of the removal of the carbonisation step 6, the need to surface treat the enhanced fibre 14 may not be necessary, thus resulting in further cost and time savings.

The method of FIG. 2 comprises: obtaining a staple fibre precursor 10, tensioning and aligning the fibre precursor along a fibre axis and subjecting the aligned staple fibre to an oxidation process 12.

### Staple Fibre

As noted above, significant cost savings in the manufacture of the enhanced fibre 14 in comparison to carbon fibre 8 are derived from adopting a staple fibre precursor 10. In an embodiment, used by the inventors, a standard knitting/craft fibre precursor 10 is used. The precursor 10 comprises the following properties: 100% Acrylic; a fibre count of approximately Nm 7.5/3+3.5%, a TPM of 135+5%, a strength of 52 N+5%, and a variable length. The diameter of the precursor need not be consistent and does vary. In this embodiment it is approximately generally 2.0 mm+1.00 mm. The colour of the precursor 10 may vary, and in one embodiment is ecru which is a light neutral colour.

The material make up, yarn weight, ply and twist is not restricted to the above dimensions and properties. A precursor 10 having different properties can be made or selected depending on the end use of the oxidated fibre. For example, the staple fibre precursor may comprise a fibre count anywhere between Nm 20/1 to Nm 5/5. The staple fibre precursor may be comprised of approximately 135+5% (TPM), in high or low bulk. The diameter of the staple fibre precursor 10 may be anywhere between 0.005 mm and up to 5.00 mm, or even higher if required.

In an alternative embodiment, a precursor 10 used may have the following properties:

Type of Yarn: 100% Acrylic non-High Bulk

Fibre Spun: Semi Dull or Dull

Count Range: 6 Nm to 32 Nm

Ply Range: 1 to 6 ply

A precursor 10 according to this alternative embodiment may be a 4/10 non-bulk acrylic fibre (that is, an acrylic fibre being 4 ply and having a 10 Nm count). In a further alternative embodiment, the type of yarn may be high bulk as opposed to non-high bulk.

The staple fibre precursor 10 may be of any reasonable material makeup. In an alternative embodiment, the staple fibre 10 is comprised entirely of naturally occurring materials, i.e. not synthesised or man-made. In this respect, the staple fibre 10 may be comprised of a single or multiple naturally occurring materials. For example, the staple fibre 10 may be comprised of at least one, or a combination of cotton, hemp, flax, jute, silk or wool. This list of naturally occurring materials is non-exhaustive.

The staple fibre precursor may be produced using hank dying. Certain polyols such as high molecular weight polyethylene glycol or polyvinyl alcohol, can be added to further improve process performance.

In a further alternative embodiment, the composition of the staple fibre 10 may be comprised entirely of synthetic materials. Examples of synthetic materials included in the composition of the staple fibre precursor 10 may be at least one, or a combination of viscose, nylon, polyester, acrylic. This list of synthetic materials is not exhaustive.

In a further alternative embodiment, the composition of the staple fibre 10 may be comprised of a combination of naturally occurring materials and synthetic materials.

In a further alternative embodiment, the staple Fibre precursor 10 is comprised of >95% (Acrylic). The remaining 5% may be a synthetic or naturally occurring material or a combination of synthetic and/or naturally occurring materials and/or by-products (which could be additives and pigments).

The dimensions and density of the precursor staple fibre 10 may influence certain end characteristics of the oxidated/enhanced fibre 14 such as density, stiffness/rigidity, fire resistance, and ductility. A staple fibre is comprised of a plurality of fibre lengths. However, the lengths of the fibres can vary. In this respect the staple fibre precursor 10 may be comprised of a plurality of short staple fibres with lengths ranged between 0.01 mm to 2.40 mm, or medium staple fibres with lengths ranging between 2.41 mm to 2.90 mm, or long staple fibres with lengths ranging between 2.90 mm to 3.50 mm or longer. Alternatively, the precursor staple fibre may be comprised of fibres of varying length, wherein the length of the individual fibres range between 0.01 mm to 5.00 mm.

### Oxidation Ovens

The oxidation process 11 involves subjecting the tensioned staple fibre precursor 10 to a gradient of increasing temperatures in successive multiple stabilisation/oxidation ovens 16. The ovens range in temperature from 50 to 500 degrees Celsius. This novel method is advantageous in that the properties of a staple fibre precursor 10 are enhanced. The oxidated staple fibre 10 at the very least possesses a fire resistance similar to that of a carbon fibre, but is produced at a fraction of the cost.

Fire resistance and other properties of the oxidised staple fibre 14 can be adjusted by amending the duration of the oxidation process 12, along with the temperature gradient of the ovens 16 used in the oxidation process 12. As can be seen in FIG. 2, during oxidation 12, the staple fibre precursor 10 runs through four ovens 16. The first oven through which the staple fibre precursor 10 passes through is set at a minimum temperature of 200° C. The second, third and fourth ovens are set above 200° C., and are arranged in ascending temperature order.

It is to be appreciated that a higher oven 16 resident time, or higher oven 16 temperatures may yield a higher fire/flame resistance, however this may also result in a decrease in ductility (increase in brittleness). The Inventors have sought oven 16 temperatures and staple fibre 10 resident times that yield a desirable balance of fire resistance and ductility for a general-purpose fibre. However, it is to be appreciated that fibre properties may be tailored to a particular use requiring a lower ductility and a higher fire resistance.

The resident time of the staple fibre precursor 10 in each oven ultimately depends on the scale of manufacture and the balance of fire resistance and ductility desired. On a small scale, the resident time ranges between 25 to 30 minutes per oven 16 for a general purpose fibre, however on a large scale, the resident time is expected to be lower for a general purpose fibre, for example between 15 to 30 minutes per oven. It is to be appreciated that resident time can be controlled by altering the speed through which the staple fibre precursor 10 is pulled through the ovens 16. Further, the resident time is determined in part by the size of the ovens 16.

It is to be noted that the resident times and temperatures specified above resulted in an enhanced oxidised fibre 14 compliant with the minimum requirements of AS1530.1 and having a tensile strength greater than 20N.

The resident time of the staple fibre precursor 10 in each oven 16, and the temperature of each oven 16 can be varied depending on the properties of staple precursor fibre 10 used, and the enhanced properties one is seeking to impart on the precursor 10. For example, if a higher fire resistance is required, the ovens may be arranged in ascending temperature order with a low gradient increase from a relatively low temperature to a relatively high temperature.

Further, and although not shown in the drawings, the oxidisation process 12 is not bound to four ovens operating in a temperature range of 200° C. and 260° C. with a residence time of 15 to 30 minutes per oven. The oxidation process 12 need only comprise of at least two ovens 16, which can range in operating temperatures from 50 to 500 degrees Celsius. The resident time may also vary anywhere between 1 minute and up to 60 minutes.

As previously noted, the ovens 14 are successively arranged in a general gradient of increasing temperature. It is to be appreciated that any two adjacent ovens 14 may be are run at the same temperature, or slightly varied temperatures, and that the gradient may be linear, polynomial, logarithmic or entirely arbitrary.

In an alternative embodiment, the ovens 16 may not necessarily be arranged in a temperature ascending order. For example, the first oven may be set to a fixed temperature of 450 degrees Celsius whereby resident time is quite low for example 20 seconds, the second oven may be set to a fixed temperature of 200 degrees Celsius, and the third oven may be set to a fixed temperature of 330 degrees Celsius.

In a further alternative embodiment, the ovens 16 may be set to vary in temperature during the resident time of the precursor 10.

### End Product and Advantages

Although the oxidated staple fibre 14 may have a comparably lower strength rating, a conductivity, and fire resistance compared to carbon fibre, the enhanced fibre 14 has been found to be more versatile due to its flexibility while still possessing similar but lower fire resistance and strength performance properties. The relatively low-cost enhanced fibre 14 generated from the novel method of FIG. 2 is much more versatile as it is cheaper and quicker to produce, more flexible/ductile compared to carbon fibre, and easier to use in a manufacturing environment due to the fibre's 14 flexibility, and lower level of conductivity. The enhanced fibre 14 is less susceptible to damage as it is comprised of a staple fibre precursor 10 having multiple stands reinforcing one another. Damage to one portion or strand will not comprise the entire fibre 16 like damage to a filament fibre would. Further the enhanced fibre 14 is less susceptible to damage as it is not anywhere near as brittle as carbon fibre. Rather it is ductile, making it more versatile as it can be used on conventional knitting and weaving manufacturing equipment without breaking. This avoids the need to modify the weaving or knitting process to accommodate for a highly brittle fibre.

Further, unlike carbon fibre, remnants and dust particles shed by the enhanced fibre 14 have low or poor conductivity, and do not pose a significant risk to the electronics of expensive manufacturing equipment. Further, the strength, fire resistance, ductility, and other properties of the oxidated/enhanced fibre 14, along with its resilience allows the fibre to be used in the composition of a wide range of products without making the production cost inhibitive. As a result, the enhanced fibre 14 can be integrated into a wide variety of products such as clothing, protective screening, curtains, and cladding.

### Alternative Embodiment

It is to be appreciated that where higher levels of fire resistance are required, the enhanced oxidised fibre 14 may also undergo a carbonisation step 6, and a surface treatment step 7. This may reduce ductility significantly, however, it will enable the oxidated and carbonised staple fibre to be used in niche products or unique applications requiring higher fire resistance than what can be provided through oxidation alone (such as in the high performance automotive, defence and aerospace industries).

It is to be understood that various alterations, modifications and/or additions may be introduced into the features previously described without departing from the spirit or ambit of this invention.

What is claimed is:

1. A method of enhancing a fibre from a staple fibre precursor comprising:
obtaining a staple fibre precursor, tensioning and aligning the fibre precursor along a fibre axis and subjecting the aligned staple fibre to an oxidation process,
wherein the oxidation process comprises subjecting the tensioned fibre precursor to a general gradient of increasing temperatures in successive multiple stabilisation/oxidation ovens, the ovens ranging in temperature from 50 to 500 degrees Celsius.

2. The method according to claim 1, wherein during the oxidation process the staple fibre precursor is passed through at least two ovens, the ovens ranging in temperature from 50 to 500 degrees Celsius.

3. The method according to claim 1, wherein during the oxidation process the staple fibre precursor is passed through at least three ovens, the ovens ranging in temperature from 50 to 500 degrees Celsius.

4. The method according to claim 1, wherein during the oxidation process the staple fibre precursor is passed through at least four oxidation ovens, the ovens ranging in temperature from 50 to 500 degrees Celsius.

5. The method according to claim 1, wherein the ovens range in temperature from 100 to 350 degrees Celsius.

6. The method according to claim 1, wherein the ovens range in temperature from 150 to 300 degrees Celsius.

7. The method according to claim 1, wherein the ovens range in temperature from 200 to 300 degrees Celsius.

8. The method according to claim 1, wherein a resident time of the staple fibre precursor in each oven ranges between 15 to 30 minutes per even, and more preferably 25 to 30 minutes per oven.

9. The method according to claim 1, wherein the staple fibre is comprised at least substantially entirely of naturally occurring materials.

10. The method according to claim 9, wherein the staple fibre is comprised of at least one of cotton, hemp, flax, jute, silk and wool.

11. The method according to claim 1, wherein the staple fibre is comprised at least substantially entirely of synthetic materials.

12. The method according to claim 1, wherein the staple fibre comprises a combination of naturally occurring materials and synthetic materials.

13. The method according to claim 1, wherein the staple fibre is comprised of at least one of viscose, nylon, polyester, acrylic.

14. The method according to claim 1 wherein the staple fibre is a short staple fibre wherein the fibre lengths of the staple fibre ranges between 0.01 mm to 2.40 mm.

15. The method according to claim 1 wherein the staple fibre is a medium staple fibre wherein the fibre lengths of the staple fibre ranges between 2.40 mm to 2.90 mm.

16. The method according to claim 1 wherein the staple fibre is a long staple fibre wherein the fibre lengths of the staple fibre ranges between 2.90 mm to 3.50 mm.

17. The method according to claim 1, wherein the staple fibre is comprised of fibres of varying length, wherein the length of the individual fibres ranges between 0.01 mm to 5.00 mm.

18. The method according to claim 1 wherein the staple fibre precursor diameter is between 0.05 mm to 5.00 mm.

19. The method according to claim 1 wherein the staple fibre precursor is at least substantially acrylic.

20. The method according to claim 1, wherein the staple fibre precursor is a yarn having a metric count anywhere between Nm 20/1 to Nm 5/5.
